(19) United States
(12) Patent Application Publication
(10) Pub. No.: US 2009/0114152 A1
(43) Pub. Date: May 7, 2009

(54) APPARATUS FOR PLASMA TREATMENT

(76) Inventors: Tooru ARAMAKI, Kudamatsu (JP); Tadamitsu Kanekiyo, Kudamatsu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/039,887

(22) Filed: Feb. 29, 2008

(30) Foreign Application Priority Data
Nov. 1, 2007 (JP) 2007-284655

(51) Int. Cl. B05C 11/00

(52) U.S. Cl. 118/712

(57) ABSTRACT

An apparatus for treating with plasma a specimen mounted on a specimen table and a next specimen mounted thereon after the treatment of the specimen is completed in a vacuumed container, comprises, a detector for measuring a temperature of the specimen table, and an adjustor for adjusting the temperature of the specimen table obtained when the next specimen is treated to have a value determined from a predetermined change in temperature of the specimen and one of the temperature of the specimen table measured by the detector and a temperature of returning refrigerant obtained after the treatment of the specimen is started, wherein the adjustor obtains the predetermined change in temperature of the specimen from the temperatures of the specimen measured in respective conditions in each of which conditions the treatment is continued until a changing rate of the temperature of the specimen becomes not more than a predetermined degree.

### BACKGROUND OF THE INVENTION

The present invention relates to a specimen treating apparatus, particularly, the specimen treating apparatus including a stage suitable for holding a specimen treated with plasma in a vacuumed condition.

As a prior art of this apparatus, JP-A-9-172003 discloses a temperature control for chamber part. In this prior art, a temperature variation in accordance with time elapse from a low temperature of the chamber part before the treatment is started to an increase in temperature of the chamber part caused by progress of the treatment is restrained by a preliminary heating with warm-up plasma performed before the treatment is started.

JP-A-7-058080 discloses that a temperature of a wafer is measured when a plasma treatment is completed, and a temperature adjustor is controlled in accordance with the actually measured wafer temperature, stage temperature and inner temperature.

JP-A-8-130237 discloses a wafer holder including a heater whose output power is controlled in accordance with a difference between a measured temperature of wafer and a target temperature.

### BRIEF SUMMARY OF THE INVENTION

In the above prior arts, the following problems are not considered. That is, in JP-A-9-172003 and JP-A-8-130237, an adjusted value of heating or cooling energy for the wafer is determined from a measured temperature of the wafer or a part of specimen table and its target temperature to perform so-called feedback control, whereby a decrease in accuracy of the temperature control caused to make a desirable temperature adjustment difficult by that in a plasma treatment apparatus for treating with plasma a specimen of substrate shape such as semiconductor wafer or the like while supplying refrigerant into a specimen table and adjusting a temperature of the refrigerant to control a temperature of the specimen table and the specimen, a time delay from outputting an order of temperature adjustment of refrigerant to a completion of change or adjustment of the temperature of specimen table or specimen is caused by a thermal capacitance of the refrigerant, has not been considered.

Further, JP-A-7-058080 discloses that a value of parameter used (or controlling value) for the next specimen to be treated subsequently is determined when the treatment of the specimen is completed, and order for adjusting the parameter to be close to a predetermined value is performed, but, since a result of the order for adjusting the parameter is not obtained before start of the treatment of the next specimen after the treatment of the specimen because of a time delay of a response in temperature of the specimen table or wafer by the adjustment or control, the treatment is started before reaching the predetermined value or being stabilized close to the predetermined value, to cause a problem of that the treatment is not performed at a desired condition, and decrease of process yield and efficiency occurs.

As mentioned above, in the prior art, it is not considered sufficiently that a response speed of adjusting the temperature of the specimen table or wafer is not sufficient when a deviation of the specimen table or wafer from the target temperature is great, and the time delay on the feedback control loop makes the desirable temperature control difficult so that the efficiency and process yield of the treatment are decreased.

An object of the present invention is to provide a plasma treatment apparatus in which a temperature of a specimen table or a specimen mounted on the specimen table is controlled accurately to improve process yield and efficiency of treatment of the specimen.

The above object is achieved by an apparatus for treating with plasma a specimen mounted on a specimen table and a next specimen mounted on the specimen table and treated after the treatment of the specimen is completed, in a vacuumed container, comprising, a detector for measuring a temperature of the specimen table, and an adjustor for adjusting the temperature of the specimen table obtained when the next specimen is treated to have a value determined on the basis of a predetermined change in temperature of the specimen and one of the temperature of the specimen table measured by the detector and a temperature of returning refrigerant obtained after the treatment of the specimen is started, wherein the adjustor obtains the predetermined change in temperature of the specimen from the temperatures of the specimen measured in respective conditions in each of which conditions the treatment is continued until a changing rate of the temperature of the specimen becomes not more than a predetermined degree.

Further, the object is achieved by that the adjustor adjusts the temperature of the specimen table obtained when the treatment of the next specimen is started, on the basis of an increase of the temperature of the specimen table measured by the detector after the treatment of the specimen is started.

Further, the object is achieved by that the specimen is transferred out of the vacuumed container after the treatment of the specimen is completed and the plasma disappears in the vacuumed container, and subsequently the next specimen is transferred into the vacuumed container to be mounted onto the specimen table.

Further, the object is achieved by that the adjustor adjusts the temperature of the specimen table obtained when the next specimen is treated, on the basis of an increase of the temperature of the specimen table obtained after the plasma is generated and a decrease of the temperature of the specimen table obtained after the plasma disappears.

Further, the object is achieved by that the adjustor adjusts the temperature of the specimen table obtained when the next specimen is treated, to have a value determined on the basis of the temperature of the specimen table measured by the detector when the specimen is treated before the plasma disappears and a predetermined change in temperature of the specimen obtained when the specimen is treated.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is an upper view showing schematically a vacuum treatment apparatus as an embodiment of the invention.

FIG. 2 is a longitudinally cross sectional view showing schematically a treatment unit of the embodiment shown in FIG. 1.

FIG. 3 is a schematic view showing a structure for adjusting a temperature of a specimen table of the embodiment shown in FIG. 2.

FIG. 4 is a graph showing an example of basis database for obtaining a forecasting formula for adjusting a temperature of heat exchange medium in the embodiment shown in FIG. 2.

FIG. 5 is a graph showing an actually measured data of temperature of the specimen table and forecasted data of temperature of the specimen table determined on the basis of database including the data as shown in FIG. 4.

FIG. 6 is a flow chart of operations for adjusting the temperature in the embodiment shown in FIG. 2.

FIG. 7a is a diagram showing conditions of parts of treatment unit of the prior art.

FIG. 7b is a diagram showing conditions of parts of the treatment unit as the embodiment shown in FIG. 2.

FIG. 8 is a longitudinally cross sectional view showing a modified example of the embodiment shown in FIG. 2.

### DETAILED DESCRIPTION OF THE INVENTION

Embodiments of the invention are described below with making reference to the drawings. In the embodiments described below to disclose an apparatus for plasma treatment, a method for operating the apparatus for plasma treatment and a method for the plasma treatment using the apparatus or methods, for making temperature conditions of wafers to be treated on a stage as a specimen table for the wafer even, from a measured temperature of the stage on which one of the wafers is mounted to be treated, the temperature of the stage to be obtained when a treatment of next one of the wafers is started on the stage is estimated, and adjusting a temperature of a refrigerant having a time delay in reaching the stage and a time delay in becoming a desired temperature so that a temperature of the stage is adjusted with a feed forward control before the treatment for a desired one of the wafers to be treated is started. According to the invention, the specimen table may be cooled by a Peltier element of high control responsibility or a so-called direct expansion type or the like in which type the specimen table is used as a part of a refrigerating cycle to vaporize the refrigerant in a refrigerant path included by the specimen table, other than the below described embodiments in which the temperature of the refrigerant is vaporized before reaching the specimen table.

### Embodiment 1

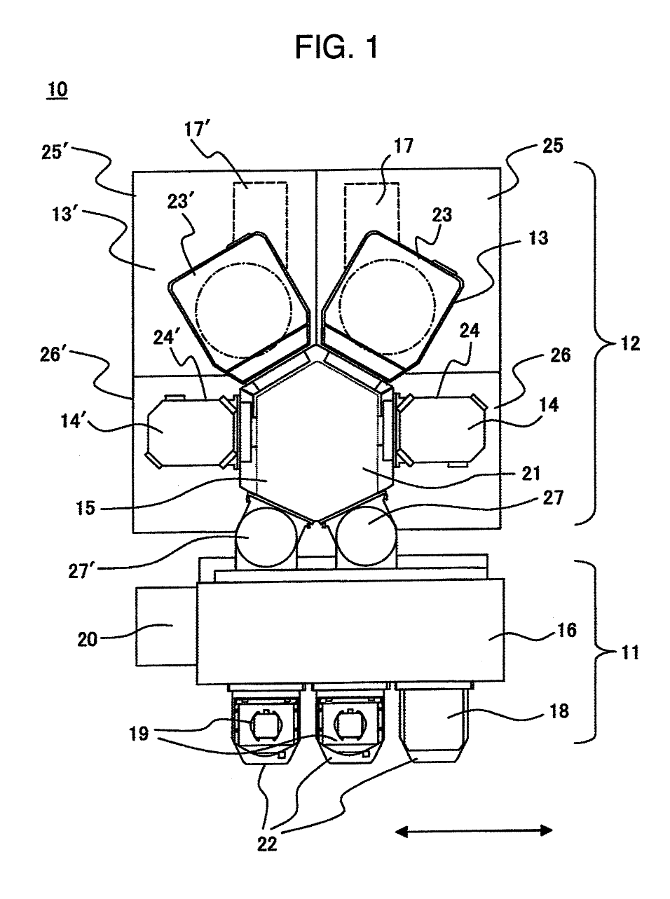

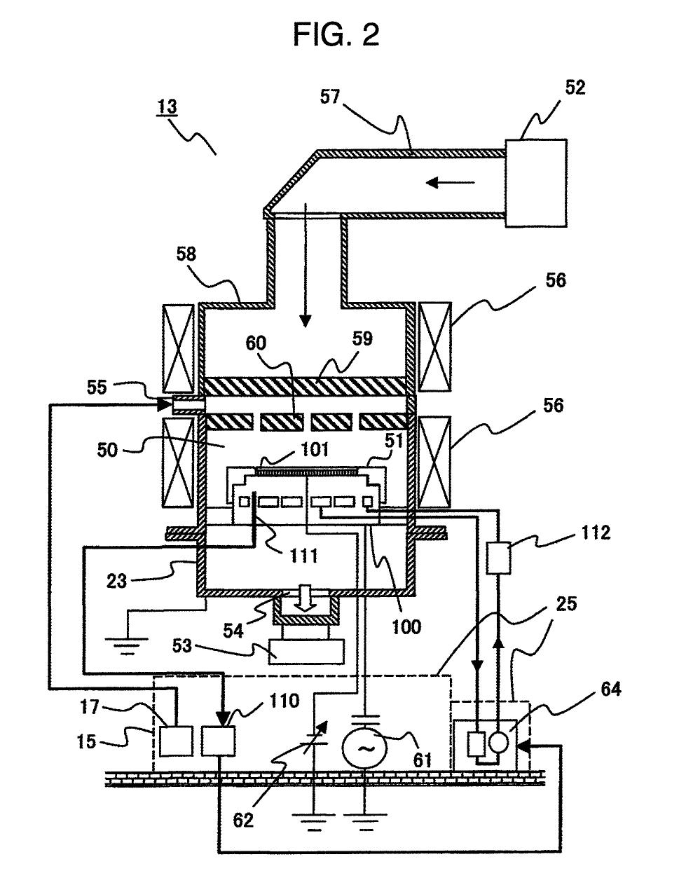

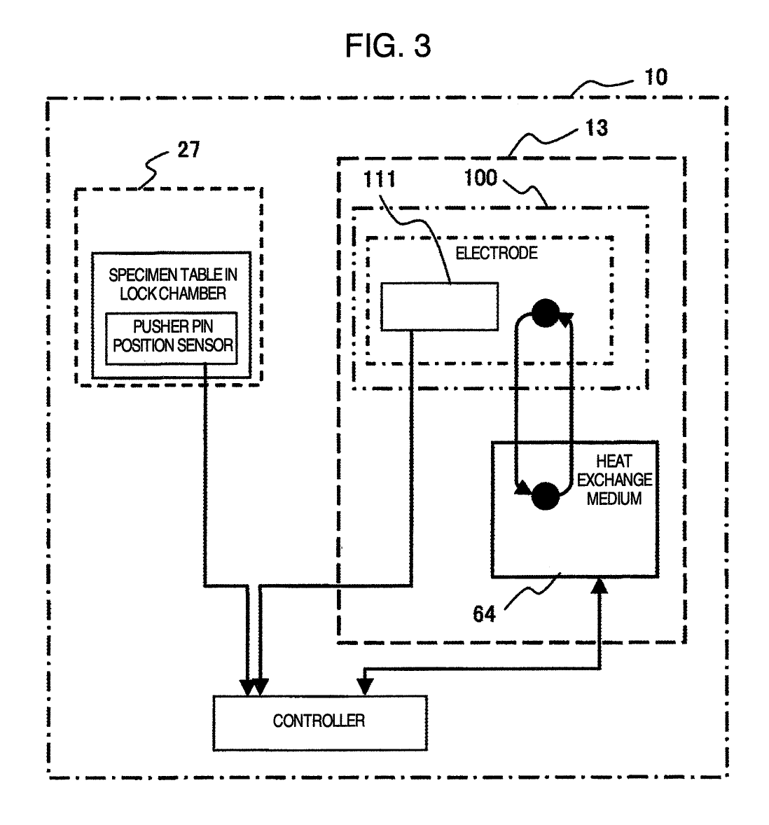

A first embodiment of the invention is described with making reference to FIGS. 1-7. FIG. 1 is an upper view showing schematically a vacuum treatment device on which a plasma treatment device as a first embodiment of the invention is mounted. FIG. 2 is a cross sectional view showing schematically the plasma treatment device as the embodiment shown in FIG. 1. FIG. 3 is a block diagram showing schematically a device for adjusting a temperature of a specimen table in the embodiment shown in FIG. 2.

In FIG. 1, the vacuum treatment device 10 of the embodiment has front and back blocks. The front block of the vacuum treatment device 10 shown in a lower part of FIG. 1 faces in a clean room or the like to a line along which a container containing a semiconductor wafer as a specimen of disk shape to be treated is transferred and another vacuum treatment device 10 or another treatment device are arranged to form a production line.

The front block of the vacuum treatment device 10 shown in the lower part (line side) of FIG. 1 is called as an atmosphere side block 11 through which the wafer to be supplied to a treatment room of the vacuum treatment device 10 is transferred in the atmosphere to a chamber whose inner pressure is decreased. The back block of the vacuum treatment device 10 above the atmosphere side block 11 in FIG. 1 is called as a treatment block 12 connected to the atmosphere side block 11.

The atmosphere side block 11 has a chassis 16 in which a transfer robot (not shown) is arranged, and a plurality (in the embodiment, three) cassette tables 22 on which a cassette 19 containing the wafers to be treated or cleaned and a cassette 18 for dummy wafer are mounted. Lock chambers 27 and 27′ as interface in which condition is changeable as a part of the treatment block 12 to transfer the wafer between the atmosphere side block 11 and the treatment block 12 are arranged on a back surface of the chassis 16.

The transfer robot in the chassis 16 transfers the wafer between the cassettes 18 and 19 and the lock chambers 27 and 27′. The atmosphere side block 11 has a positioning part 20 at a side (left or right side in FIG. 1) of the chassis 16 so that the wafer transferred by the transfer robot is positioned in the positioning part 20 in accordance with a desired orientation of the wafer in the cassettes 18 and 19 or the lock chambers 27 and 27′.

The treatment block 12 has a vacuum transfer chamber 21 of polygonal shape (in the embodiment, hexagonal shape) as seen vertically in which chamber a degree of vacuum is kept high to transfer the wafer therein, and an atmospheric transfer unit 15 arranged at a front side of the vacuum transfer chamber 21 to connect the atmosphere side block 11 and the lock chambers 27 and 27′ to each other. Treatment units 13, 13′, 14 and 14′ each of which has a vacuum chamber to be vacuumed and a the treatment room arranged in the vacuum chamber to treat the wafer therein and the lock chambers 27 and 27′ connecting the atmosphere side block 11 to the atmospheric transfer unit 15 and the treatment units 13, 13′, 14 and 14′ are connected to respective edges of polygonal periphery of the vacuum transfer chamber 21. These units are depressurized to be kept at the high degree of vacuum so that the treatment block 12 are used for the vacuum treatment.

The treatment units 13 and 13′ of the treatment block 12 are arranged respective ones of the edges of polygonal periphery adjacent to each other at a rear end of the vacuum transfer chamber 21. In the embodiment, the treatment units 13 and 13′ includes respective treatment chambers in which the wafers transferred from the cassette 19 to the treatment block 12 are etched.

The treatment units 14 and 14′ of the treatment block 12 are arranged respective ones of the edges of polygonal periphery adjacent to each other at a side end (left or right side) of the vacuum transfer chamber 21. In the embodiment, the treatment units 14 and 14′ includes respective treatment chambers in which ashing is applied to the wafers to be transferred from the cassette 19 or the treatment units 13 and 13′. The treatment units 13, 13′, 14 and 14′ are detachably attached to the transfer unit 15. In other words, the wafer is transferred between the lock chambers 27 and 27′ and the treatment units 13, 13′, 14 and 14′ through the vacuum transfer chamber 21 in which the vacuumed condition is kept.

The lock chambers 27 and 27′ are connected to a vacuuming device (not shown) so that insides thereof for receiving therein the wafers respectively to be treated are changed between the high degree of vacuum and the atmospheric pressure and are opened and closed by gate valves (not shown) arranged front and back ends thereof in the drawing to be enabled to communicate with selected one of the vacuum transfer chamber 21 and the atmospheric side block 11 or chassis 16. In the embodiment, the lock chambers 27 and 27′ have the same function so that any one of them is not allowed to perform only one of a pressure variation (loading) applied to the wafer from the atmospheric pressure to the vacuumed condition and another pressure variation (unloading) applied to the wafer from the vacuumed condition to the atmospheric pressure, but if desired, one of them may be limited to perform only one of the pressure variations.

In the treatment block 12, the treatment units 13 and 13′ have respective vacuumed containers 23 and 23′ including respective treatment rooms in which the pressure is decreased to perform the etching. An exhausting device is arranged below the vacuumed containers 23 and 23′ to depressurize the treatment rooms in the vacuumed containers 23 and 23′ as described below. Each of the treatment units 13 and 13′ is fixedly supported by beds 25 and 25′ supporting the vacuumed containers 23 and 23′ and the exhausting device connected to the vacuumed containers 23 and 23′ and a plurality of supporting columns arranged on the beds 25 and 25′ to connect the vacuumed containers 23 and 23′ to the beds on a floor on which the vacuum treatment device 10 is arranged.

Coil cases containing therein respective electromagnetic coils for generating magnetic fields to form plasma in the respective treatment chambers arranged on the vacuumed containers 23 and 23′ are arranged on the vacuumed containers 23 and 23′. An electric wave source including an electric source for generating electric fields in the treatment chambers and a wave guide through which the electric field is applied to the treatment chambers is arranged above the coil case.

The treatment units 14 and 14′ have respective vacuumed containers 24 and 24′ including respective treatment rooms in which the pressure is decreased to perform the ashing, and an exhausting device is arranged below the vacuumed containers 24 and 24′ to depressurize the treatment rooms in the vacuumed containers 24 and 24′. The treatment units 14 and 14′ are fixedly supported by beds 25 and 25′ supporting the vacuumed containers 24 and 24′ and the exhausting device connected to the vacuumed containers 24 and 24′ and a plurality of supporting columns arranged on the beds 26 and 26′ to be connected to the vacuumed containers 24 and 24′.

In lower beds 25 and 25′, gas supply units 17 and 17′ for adjusting a gas to be supplied into the vacuum containers 23 and 23′ to treat the specimen, are arranged. In lower beds 26 and 26′, gas supply units (not shown) for adjusting a gas to be supplied into the vacuum containers 24 and 24′ to treat the specimen, are arranged.

The plasma treatment devices as the treatment units 13 and 13′ of the treatment block 12 of the vacuum treatment apparatus 10 are described below with making reference to FIG. 2. FIG. 2 shows schematically the treatment unit 13 shown in FIG. 1, and the treatment unit 13 includes the bed 25, the vacuum container 23 on the bed 25 and the other devices attached or arranged around the vacuum container 23. The vacuum container 23 on the bed 25 contains a of substantially tubular shape, and a stage 51 including a specimen table 100 for holding thereon a specimen 101 such as a semiconductor wafer as a substrate to be treated is contained by the treatment room 50.

The bed 25 arranged at a lower part of the treatment unit 13 contains a temperature adjustor 64 for supplying a heat exchange medium supplied into the specimen table 100 while keeping a temperature of the heat exchange medium at a predetermined degree, a high-frequency electric source 61 for supplying a high-frequency electric power to an electrode arranged in the specimen table 100 and made of electrically conductive material such as aluminum, titan or the like to generate a bias electric potential on an upper surface of the specimen 101, and a direct current electric source 62 for supplying an electric power to hold the specimen 101 with electrostatic attraction on a specimen mounting surface as an upper surface of the stage 51 through a dielectric layer of substantially circular shape forming the specimen mounting surface. The temperature adjustor 64 receives the heat exchange medium discharged from the specimen table 100 to make the heat exchange medium have the predetermined temperature, and subsequently supplies the heat exchange medium into a passage extending substantially helically in the specimen table 100 and having a substantially rectangular cross sectional shape.

In this embodiment, the electrode arranged in the specimen table 100 and made of metallic material to have a thermal conductivity higher than that of the dielectric layer includes a refrigerant passage through which the heat exchange medium flows so that the heat exchange medium flows through the refrigerant passage in the electrode to perform a heat exchange for adjusting the temperatures of the specimen table 100 and the specimen 101 on the specimen table, and subsequently flows out of the specimen table 100 to return to the temperature adjustor 64 to form a circulation. The refrigerant passage extends coaxially or spirally to exist at a plurality of positions distant from each other in a radial direction from a center of the specimen table 1 of substantially tubular shape and the electrode. The heat exchange medium flows out of the temperature adjustor 64 in a rectangular container as a part of the bed 25, flows into the refrigerant passage at a radially outer edge of the specimen table 100, flows circumferentially to orbit around the center in a plurality of times while flowing radially inward, and flows out of the specimen table 100 at a radially inner edge thereof to return to the temperature adjustor 64. The heat exchange is applied to the heat exchange medium in the temperature adjustor 64 so that the heat exchange medium has the predetermined temperature or a temperature close to the predetermined temperature, and subsequently the heat exchange medium flows toward the refrigerant passage.

A gas source for supplying a gas of thermal conductivity to a clearance between the upper surface of the specimen table as the specimen mounting surface and a back surface of the specimen 101 and a gas feed unit 17 for adjusting a flow rate of the treatment gas to be supplied into the treatment room 50 in the vacuum container 23 and changing a kind of the treatment gas are arranged in the bed 25. The bed containing these devices has a substantially rectangular shape having a flat upper surface on which a worker is capable of handling the vacuum container and so forth.

An electric wave source for generating the electric field to be applied to the treatment room 50, a device for generating a magnetic field thereto and a vacuuming device 53 including a vacuum pump for depressurizing the inside of the treatment room 50 are arranged on the vacuum container 23 arranged at an upper portion of the treatment unit 13. In the treatment room 50, a shower plate 60 is arranged above the specimen mounting surface of the specimen table 100 and has a substantially discal shape of diameter greater than a diameter of the specimen 101 to form a roof of the treatment room 50 facing to the specimen mounting surface. The shower plate 60 has a plurality of through-holes surrounding a center thereof substantially coaxial with a center of the specimen table 100 or the specimen 101 to be mounted on the specimen table 100 so that the treatment gas is supplied from the gas supply unit 17 through the through-holes to the roof of the treatment room 50.

A window member 59 made of dielectric material (for example, quartz) and having substantially discal shape is arranged above the shower plate 60 with a predetermined distance therebetween so that the electric field supplied from an upper region of the window member 59 is applied through the window member 59 and the shower plate 60 into the treatment room 50. The electric field is applied to a space between the specimen table 100 and the shower plate 60 to generate the plasma of the treatment gas. A space in the vacuum container 23 above the window member 59 has a substantially cylindrical shape suitable for generating resonance of the electric field supplied from the electric wave source above the space.

The plasma, reactive gas and particles such as product of reaction formed by the treatment flow into a lower region of the vacuum container 23 under the specimen table 100, and an opening 54 is arranged at a bottom of the vacuum container 23 and communicating with the vacuuming device 53 to remove the particles from the treatment room 50. A Rotary flapper of plates is arranged in a passage between the opening 54 and the vacuuming device 53 and rotated to change a cross sectional area of the passage so that an exhaust flow rate from the treatment room 50 by the vacuuming device 53 is adjusted.

A magnetron 52 as the electric wave source for generating the electric field in the treatment room 50 is arranged above the vacuum container 23 so that microwave generated by the magnetron 52 proceeds substantially horizontally in the wave guide 57 of substantially rectangular cross section, and is directed to proceed vertically downward to the space for the resonance above the window member 59. The electric field of the microwave resonating in the space at the predetermined frequency is applied to the treatment room through the window member 59 and the shower plate 60. The treatment gas is supplied from the gas supply unit 17 through a treatment gas inlet port 55 into the space between the window member 59 and the shower plate 60 to fill the space so that the treatment gas is supplied through the through-holes of the shower plate 60 toward the specimen table in the treatment room 50.

The specimen 101 transferred to be mounted on the specimen table 100 is held on the specimen mounting surface by the electrostatic attraction generated by the electric power supplied to the electrode of layer shape surrounded by the dielectric layer forming the specimen mounting surface, and the treatment gas supplied into the treatment room 50 is excited by a mutual action of the microwave and the magnetic field generated in the treatment room 50 by a solenoid coil arranged as a horizontal side or upper side of the vacuum container 23 to generate the plasma. At least one exposed layer of the specimen 101 to be treated is etched in the plasma. During the etching, the predetermined bias electric potential is generated on the specimen 101 by the high frequency electric power supplied to the electrode in the specimen table 100 from the high-frequency electric source 61 so that charged particle in the plasma is attracted toward the specimen surface in accordance with an electric potential difference between the bias electric potential and the electric potential of the plasma to facilitate the anisotropic etching. In such etching treatment, the product is formed in the treatment room 50.

The plasma, treatment gas, particles such as the product and so forth move into the space under the stage 51 through a passage between an inner wall of the treatment room 50 and a side wall of the stage 51 in the vacuum container 23 to be discharged from the treatment room 50 through the opening 54 by the vacuum device 53. When the specimen 101 is treated, a balance between the supply of the treatment gas adjusted by the gas supply unit 17 and the discharge through the opening 54 by the vacuum device 53 is kept to keep the pressure in the treatment room at the predetermined degree.

The opening 54 is substantially circular and is arranged coaxially with the central axis of the specimen table of substantially cylindrical shape, and in the embodiment, the treatment room 50, the window member 59, the shower plate 60, the specimen table 100, the opening 54 and the vacuum pump of the vacuuming device 53 are arranged coaxially with each other. In such structure, the evenness of treatment around the axis and the circumferential evenness of treatment on the specimen 101 are improved to increase the process yield of the treatment. Incidentally, the embodiment includes a controller 110 in which for coordinating operations of parts of the vacuum treatment device 10 including the treatment units 13, signals generated by sensors for detecting the operations of the parts are received through communication means, and signals for ordering the operations of the parts are outputs through the communication means on the basis of the result of detecting the conditions of the parts from the received signals.

For example, the controller 110 receives an output of a temperature sensor 111 fixedly arranged in the electrode in the specimen table 100 to measure a temperature of the specimen table 100 or the electrode from the output. The temperature is calculated by a calculator arranged in the controller 110 along a predetermined relationship obtained experimentally or theoretically between the output value from the temperature sensor 111 and a temperature of the specimen mounting surface of the specimen table 110 or a temperature of the metallic electrode whose temperature is assumed to be even over the whole of the electrode. A temperature of a surface of the specimen 101 may be calculated from the temperature of the specimen table 110 or the temperature of the electrode. The calculated value may be the temperature, or data corresponding to the temperature.

The controller 110 calculates a difference between a desired value and the calculated data value corresponding to the temperature of the specimen table 110 or the specimen 101 to determine a temperature of heat exchange medium of the temperature controller 64 in accordance with the difference and to output an order signal of the determined temperature to the temperature controller 64. The temperature controller receiving the order signal adjusts the temperature of heat exchange medium in accordance with the order signal so that a refrigerant cycle is driven to make the temperature of heat exchange medium become the determined temperature.

The temperature controller 64 of the embodiment has the refrigerating cycle, a heater and a refrigerant passage through which the refrigerant flows so that a heat exchange between the refrigerant flowing through the refrigerant passage and the refrigerating cycle or heater is performed to keep the temperature of the refrigerant within a predetermined range. Particularly, when the temperature of the heat exchange medium flowing through the specimen table 100 of the plasma treatment apparatus is adjusted, since the temperature of the specimen table 100 is generally increased during the treatment of the specimen so that the temperature of the refrigerant flowing out of the specimen table 100 is higher than the temperature of the refrigerant flowing into the specimen table 100, the temperature controller 64 drives the refrigerating cycle to cool the heat exchange medium. In such a manner, a cooling performance of a cooler (evaporator) as a part of the refrigerating cycle is adjusted to adjust the temperature of the heat exchange medium.

FIG. 3 shows schematically a structure for adjusting the temperature of the specimen table of the plasma treatment apparatus. In the embodiment, the temperature sensor 111 is arranged in the electrode included by the specimen table 100, and an end thereof contacts a metallic part of the electrode to measure the temperature of the electrode during the treatment of the specimen 101. The output of the temperature sensor 11 as the measured temperature is received by the controller 110. During the treatment of the specimen 101, the temperature of the electrode is measured at intervals of predetermined sampling time period so that a variation in temperature of the electrode during the treatment is detected by the controller 110. The temperature sensor 111 of the invention is of Pt 100 Ω, but may be a thermo couple, thermistor, fluorescene temperature indicator or the like.

The output of the temperature sensor as the measured temperature is transmitted to the controller 110 to calculate the temperature of the electrode or the data corresponding thereto through the calculator included by the controller and a program or correlation data recorded by a memory device. From the calculated data or the like, the calculator calculates the order for controlling the temperature through the program corresponding to a controlling formula obtained from a result of experiment or theoretical analysis, and the order is output to the temperature adjustor 64. The temperature adjustor 64 receiving the order adjusts the temperature of the heat exchange medium in accordance with the order to become the ordered temperature by adjusting the operation of the refrigerating cycle.

In the embodiment, the order to be received by the temperature controller 64 to adjust the temperature of the heat exchange medium is used to adjust the temperature of the specimen 101 to be treated next, and is used to adjust the temperature of the heat exchange medium so that the electrode has a desired temperature suitable for treating the specimen when the treatment of the specimen to be treated next is started. The controller 110 may order the temperature adjustor 64 the temperature of the specimen 101 or electrode calculated by the calculator to be obtained when the treatment of the specimen to be treated next is started so that the temperature adjustor 64 calculates the temperature of the heat exchange medium for obtaining the ordered temperature calculated by the calculator included by the temperature adjustor 64 and adjusts the operation of the refrigerating cycle to make the circulating heat exchange medium have the calculated temperature.

As described below, in the embodiment, the order for the temperature transmitted from the controller 110 to the temperature adjustor 64 is output before the treatment of the specimen to be treated before the specimen to be treated next is completed, and the desired temperature of the heat exchange medium is changed by the temperature adjustor 64 in accordance with the order to change the temperature of the refrigerant. That is, before completing the treatment of the specimen to be treated before the specimen to be treated next, an operational condition for changing the temperature is started with taking into consideration a time delay caused by a thermal capacity of the heat exchange medium.

As a trigger signal for ordering the change of temperature, in the embodiment, a signal output when a predetermined operation for transferring the specimen 101 in the lock chamber 23 is detected is used. That is, the lock chamber 23 includes a specimen table (not shown) through which the specimen 101 is transferred between the treatment block 12 and the atmosphere side block 11 (vacuum transfer chamber 21 and chassis 16).

This specimen table includes a plurality of pusher pins movable between a lower position at which they are contained in the specimen table and an upper position at which they protrude from a mounting surface of the specimen table to receive the specimen with a clearance between the specimen and the mounting surface when the specimen is positioned over the mounting surface. The pusher pins protrude vertically upward from the mounting surface through openings of the mounting surface corresponding to the pusher pins to contact a back surface of the specimen 101 to be supported by the pusher pins. Therefore, the pusher pins are slim bars having respective strengths sufficient for supporting the specimen 101.

The pusher pins are moved vertically in accordance with the order from the controller 110 by a driving device arranged in or below the specimen table, and front ends of the pusher pins are positioned at the lower position below the mounting surface to be retracted in the specimen table below the openings. In the embodiment, a sensor is arranged on the specimen table of the driving device to detect the position of the pusher pins so that a signal is output to the controller 110 when the pusher pins reach the upper position as the highest position thereof.

Accordingly, the controller 110 detects a timing of transferring to the treatment unit 13 or the like the specimen to be treated next, before it is transferred into the vacuum chamber 23 or the like. Although the signal output in response to that the pusher pins in the lock chamber 23 reach the upper position is used in the embodiment, an output as digital signal generated by a sensor for detecting a movement of the specimen 101 to be transferred into the treatment room 50 in the vacuum chamber 23 or a pair of light emitter and light receiver opposed to each other vertically to detect that a light is interrupted by the specimen 101 between the light emitter and light receiver as an interrupted light sensor may be used. Further, the order for adjusting the temperature does not need to be output to the temperature adjustor 64 just after the controller 110 receives the signal, the order for starting the adjustment of the temperature may be output at any time with software.

The order output from the controller 110 in the embodiment is analog signal, and when the controller is not used to order the desired temperature of the heat exchange medium, a switch operable to change a connection from the other part of the plasma treatment apparatus to one of the temperature adjustor 64 and the controller 110 may be arranged so that the order from the other part of the plasma treatment apparatus is directly received by the temperature adjustor 64.

The temperature adjustor 64 adjusts in accordance with the order the temperature of the heat exchange medium to be supplied to the electrode. Although in the invention, the temperature adjustor 64 includes the refrigerating cycle and the passage for the heat exchange medium thermally connected to the cooler of the refrigerating cycle so that the temperature of the heat exchange medium flowing through the passage is adjusted by a thermal conduction between the heat exchange medium and the cooler, a heat exchange element such as Peltier element or the like may be used as substitute for the cooler. With this structure, while a plurality of the specimens 101 as a treatment lot are treated continuously in any one of treatment units 13, 13′, 14 and 14′, a variation in temperature of the specimen table 100 and the specimens 101 is restrained to perform the treatment of high accuracy so that the process yield and efficiency of the treatment is improved. Incidentally, a number of 112 in FIG. 2 denotes a heater for increasing a response speed or a temperature control element such as Peltier element or the like.

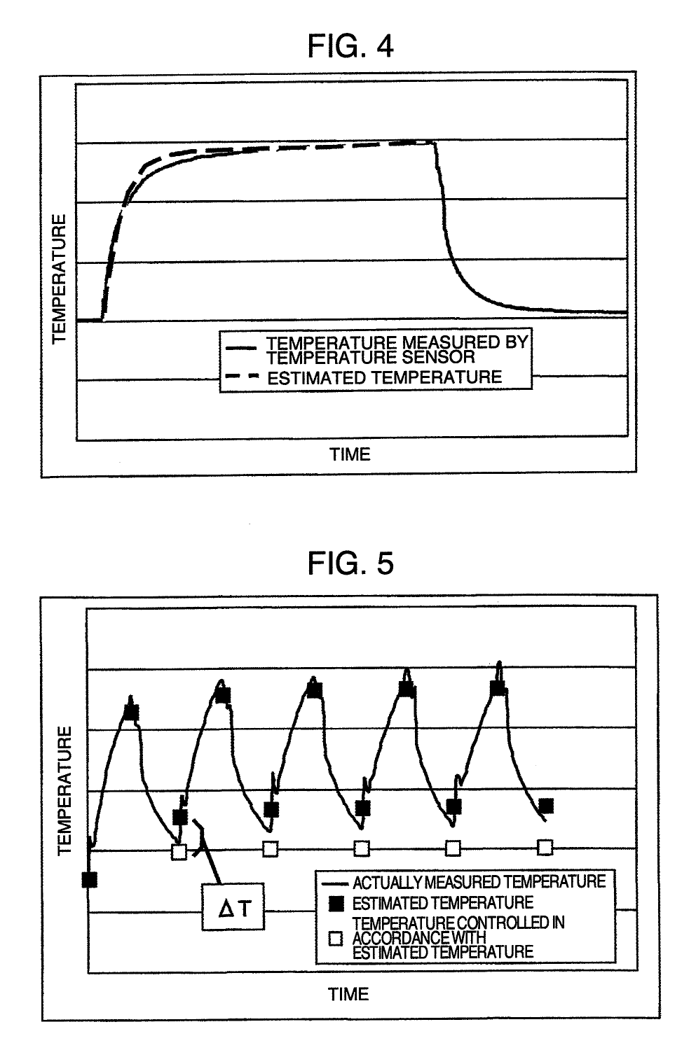

The order for adjusting the heat exchange medium to be transmitted to the temperature adjustor 64 from the controller 110 is described with making reference to FIGS. 4 and 5. FIG. 4 shows a variation in temperature of the specimen table (electrode) measured by the temperature sensor of the embodiment along a time proceeding of the treatment of the specimen and a variation in temperature of the specimen table (electrode) calculated by the controller of the embodiment along the time proceeding of the treatment of the specimen. The variation in temperature of the specimen table 100 is calculated from RF (high frequency) bias corresponding to a thermal energy (heating energy) applied by the plasma to the specimen 101 and the specimen table 100, a time period of the treatment, and parameters K and P corresponding to respectively increasing rate and decreasing rate of the temperature.

In the embodiment, the parameters K and P vary in accordance with a voltage value (highest or average voltage value) of the RF bias, but do not vary to correspond to the increasing rate and decreasing rate when the voltage value of the RF bias is kept constant. The parameters K and P show the variation in temperature obtained after the plasma is generated and after the plasma disappears, and are necessary for calculating correctly the temperature obtained during the treatment.

The parameters K and P are functions on the heating energy applied by the plasma, and may be determined from the variation in temperature of the specimen table 100 measured after the plasma is generated to start the treatment on the specimen 101 which is held on the specimen table 100 having a predetermined temperature and whose temperature is kept at the predetermined temperature or within a predetermined range around the predetermined temperature. Particularly, in the embodiment, the parameters K and P are determined from the variation in temperature measured until the temperature decreases to be sufficiently close to the predetermined temperature after the plasma is not generated to finish the treatment after the plasma is generated and the temperature of the specimen table 100 increases to be saturated.

Alternatively, the variation in temperature obtained when each of the bias electric powers different from each other is supplied to enable the plasma to generate corresponding one of heat energies different from each other as shown in FIG. 4 may be measured to form a data base so that the parameters K and P are determined from at least two points on the variation in temperature. The greater a number of the points is, the higher an accuracy of determining the parameters K and P is. The parameters K and P corresponding to a characteristic of the variation in temperature varied in accordance with a variation of the supplied heat energy are obtained from the measured variation in temperature.

The data base is used to determine the parameters K and P. In the embodiment, the specimen table 100 is thermally isolated by the vacuum container 23 to be restrained from being influenced by an outside of the vacuum container 23 so that the data as shown in FIG. 4 in the data base is utilized with high repeatability for the treatment of the specimen 100 for producing a semiconductor device. Although the parameters K and P for forecasting the temperature of the specimen 100 are determined along the below formula 1 and the temperature of the specimen 100 is forecasted along the formula 1, another formula may be used.

The temperature sought by the temperature adjustor 64 can be deemed to be constant before starting the treatment, during the treatment and after the treatment when the treatment is performed as a preliminary experiment, theoretical analysis and simulation. Therefore, as shown in FIG. 4, after the bias and plasma disappear after the treatment of the specimen 101 is finished, the temperature of the specimen table 100 gradually becomes close to the temperature at which the treatment is started.

In the embodiment, the parameters K and P are determined through repeated calculations to satisfy with a predetermined acceptable deviation the experimental result data in which the specimen is heated from the predetermined start temperature and subsequently the temperature thereof gradually becomes close to the saturated temperature. A formula between the temperature and the supplied thermal energy is determined after the parameters K and P are determined. Incidentally, the below formula 1 is along a basic equation of unsteady unidimensional heat transmission. By the calculation along the formula 1, the temperature of the wafer obtained after a given time period has elapsed from the time at which the measurement is performed is forecasted by the controller 110 to calculate a needed operational value of the temperature adjustor 64 so that the order including the operational value is transmitted to the temperature adjustor 64.

Particularly, the formula 1 includes a time period of temperature increase and a time period of temperature decrease as parameters thereof, and a maximum value of the time period of temperature increase is used as a constant number for the time period of temperature decrease. Further, the temperature increase and the temperature decrease have respective signs inverted to each other, and the parameters K and P are applied to the temperature increase and the temperature decrease. In the formula, by using the parameters K and P obtained from the temperature increase, the decrease of the temperature is forecasted.

specimen temperature=(specimen initial (measured) temperature)+(−EXP(−time period of temperature increase*K)/P/K+EXP(time period of temperature decrease*K)/P/K formula 1

FIG. 5 is a graph showing data actually forecasted along the formula used to form FIG. 4. This drawing shows the actually obtained variation in temperature of the specimen table 100 (shown by solid line) and the forecasted variation in temperature thereof (shown by rectangular black block) obtained when the plurality of the specimens 100 of given one of the lots in each of which lots the specimens have the same layer structure including a plurality of stacked films with sufficient evenness among the specimens are treated, by using the treatment unit 13, in the treatment room 50 continuously during a time period other than a time period for transferring the specimens 101.

A set of one ascent and subsequent one descent in FIG. 5 is a profile of temperature variation from the start in treatment of the specimen 101 to the start in treatment of the specimen to be treated subsequently through the treatment of the specimen, the disappearance of plasma (treatment completion) and the mounting of the specimen to be treated subsequently onto the specimen table 100. In the embodiment, the calculator in the controller 110 operates along a program recorded in the memory device (not shown) in the controller 110 to calculate or select the suitable parameters K and P on the basis of the temperature increase measured after the treatment of the specimen 101 and the above mentioned data base as the predetermined relationship between the parameters K and P and the previously obtained temperature increase. Further, a time at which the treatment of the specimen to be treated subsequently is started is estimated or obtained to forecast, along the formula 1 on the basis of the parameters K and P and the time at which the treatment of the specimen to be treated subsequently is started, the temperature to be obtained at the time at which the treatment of the specimen is completed and the temperature to be obtained at the time at which the treatment of the specimen to be treated subsequently is started.

The controller 110 calculates a difference between the temperature obtained at the time at which the treatment of the specimen or first one of the specimens of the lot which lot is now treated is started and the forecasted temperature to be obtained at the time at which the treatment of the specimen to be treated subsequently is started, so that the temperature controller 64 outputs the order for controlling the temperature of the heat exchange medium in accordance with the difference. The output of the order is made earlier than the time at which the treatment of the specimen to be treated subsequently is started, by a time delay (time constant) predetermined by the calculator in the controller 110 as a characteristic of a temperature variation of the specimen table 100 in response to a temperature variation of the heat exchange medium generated by the temperature adjustor 64. The temperature adjustor 64 receiving the order changes with the refrigerating cycle or the heater the temperature of the heat exchange medium in accordance the order corresponding to the difference. A timing of outputting the order or of starting the change of the temperature of the heat exchange medium may be modified in accordance with a different in structure such as a length of passage for the heat exchange medium, a thermal capacitance of the electrode and for forth.

In the embodiment, the refrigerant as the heat exchange medium includes water and chloro-fluorocarbon or compound thereof as corrosion inhibitor to cause an increase of the time delay, but the time delay by such refrigerant is smaller than a time period of the specimen 101, that is, a time period from a time at which the treatment of the specimen 101 is started to a time at which the treatment of the specimen to be treated subsequently is started. On the other hand, the time delay is greater than a time period from a time at which the treatment of the specimen 101 is completed to the time at which the treatment of the specimen to be treated subsequently is started. Therefore, the timing of outputting the order or of starting the change of the temperature of the heat exchange medium is before an forecasted time at which the treatment of the specimen 101 will be completed. In this case, the variation in temperature of the specimen table 100 caused by the variation in temperature of the heat exchange medium is prevented by the time delay substantially from affecting the specimen 101 being treated.

As shown in FIG. 5, the temperature adjustor 64 decreases the temperature of the heat exchange medium before the treatment of the specimen 101 to be treated subsequently is started so that the temperature of the specimen table 100 to be obtained when the treatment of the specimen 101 to be treated subsequently is started is decreased by ΔT from the forecasted temperature of the specimen table 100 toward the temperature of the specimen table 100 obtained when the treatment of the first one of the specimens 101 of the lot is started. After the treatment of the subsequent specimen 101 is completed, ΔT corresponding to the difference between the forecasted temperature of the specimen table 100 and the temperature of the specimen table 100 obtained when the treatment of the first one of the specimens 101 of the lot is started is calculated to determine the change in temperature of the heat exchange medium controlled by the temperature adjustor 64. By such operation, a variation of the temperatures of the specimen table 100 each of which temperatures is measured when the treatment of respective one of the specimens is started is decreased while the specimens of the lot are treated continuously.

That is, □ mark indicating the temperature of the specimen table obtained by changing the temperature of the heat exchange medium shows a smaller variation in comparison with ▪ mark indicating the temperature of the specimen table obtained without changing the temperature of the heat exchange medium. In this embodiment, during a time period from the start of the treatment of the specimen 101 to outputting the above mentioned order and a time period from outputting the above mentioned order to the start of the treatment of the specimen 101 to be treated subsequently, the temperature ordered by the temperature adjustor is kept constant. Therefore, during each of the time periods, the refrigerating cycle or the heater in the temperature adjustor 64 is controlled in accordance with a thermal energy applied to the heat exchange medium to have the ordered temperature. In the prior art, a thermal energy supplied for the specimen 101 to be treated just before the treatment is started and just after the treatment is started is small so that a load to the refrigerating cycle is low.

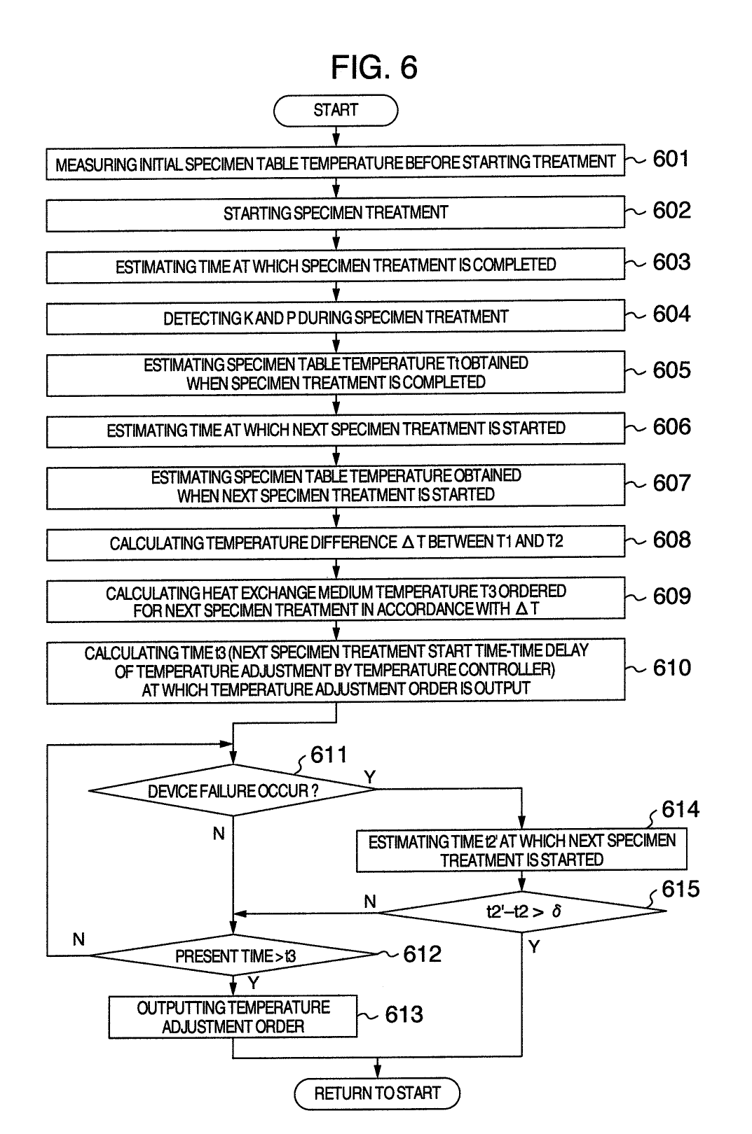

FIG. 6 shows a flow chart of adjusting the temperature of the specimen table 100 in the plasma treatment apparatus as the embodiment shown in FIG. 2. The temperature control along the flow chart is performed for the specimen to be treated subsequently. Incidentally, when a trouble occurs, for example, a time period from the treatment of the specimen and the treatment of the specimen to be treated subsequently is increased undesirably to decrease excessively the temperature obtained when the treatment of the specimen to be treated subsequently is started, the order for the first one of the specimens is output again so that the specimen to be treated subsequently has the same temperature as the first one of the specimens. If, for example, the specimen to be treated subsequently is fifth one of the specimens, the (initial) order for the first one of the specimens is output, when the trouble occurs.

That is, at step 601, a temperature T1 of the specimen table 100 is measured as an original temperature before the first one of the specimens 101 of any one of the lots is treated. The original temperature T1 is used as a reference temperature of the specimen tale 100 for treating the specimens 101 of the lot. The treatment of the specimen 101 is started at a time t0 (step 602) so that the temperature of the specimen table 100 increases from an initial temperature T1. The calculator of the controller 110 forecasts the time at which the treatment will be completed before the start of the treatment, from the time period of the treatment included by the treatment condition (recipe) of the specimen 101 received by the controller or the time period of the treatment calculated from a thickness of layer to be treated and a treating velocity (step 603).

Rather than receiving recipe for the specimen 101 or each of the lots, the operating condition of the treatment unit 13 as the plasma treatment apparatus or the vacuum treatment apparatus 10 recorded by the memory device of the controller 110 arranged outside of the treatment unit 13 or the vacuum treatment apparatus 10 may include the initial temperature and the time period of the treatment, or the order received by the controller 110 from a host computer arranged in a clean-room or the like containing the vacuum treatment apparatus 10 to control the operation of the semiconductor manufacturing devices, may include the initial temperature and the time period of the treatment. Further, the operating condition of the treatment apparatus may include the ordered temperature for the temperature adjustor, the operating condition of the refrigerating cycle or heater, the time delay and so forth so that the controller 110 calculates or selects the order for the temperature controller 64 on the basis of the operating condition.

The temperature increase of the specimen table in accordance with progress of the treatment of the specimen 101 is measured by a temperature sensor 111 so that the controller 110 calculates the parameters K and P as the characteristic of temperature variation of the specimen table 110 on the basis of the measured temperature increase. In the embodiment, the calculation may be performed by selecting the parameters K and P from the previously obtained data base. A temperature Tt at the time t1 of treatment completion obtained at the step 603 is calculated from the parameters K and P, the formula 1 and the present time (step 605).

Subsequently, a time t2 where the specimen 101 to be treated subsequently is started after being mounted on the specimen table 101 as a substitute for the treated specimen 101 is obtained from the predetermined recipe or the operation of the apparatus (step 606). The time at which the specimen 101 to be treated subsequently is started is calculated by the controller 110 from the operation of the vacuum treatment apparatus 10, particularly a position of the specimen 101 to be treated subsequently or a condition of the treatment in the other treating unit. Further, the temperature T2 obtained at the time t2 of the treatment completion is calculated by the controller 110 from the parameters K and P, the formula 1 and the temperature Tt (step 607).

Subsequently, the controller 110 calculated the difference ΔT between the temperature T2 calculated at the step 607 and the initial temperature T1 of the specimen table so that a temperature T3 of the heat exchange medium ordered by the controller 110 is calculated on the basis of the difference ΔT to obtain a temperature of the specimen table 100 necessary for the specimen to be treated subsequently (step 608, 609). Further, a time t3 where the order is output before the time where the treatment of the specimen to be treated subsequently is started is calculated with taking the time delay included by the operation condition or the like into consideration (step 610). In the embodiment, the calculation of the time t3 is performed during the treatment of the specimen so that the order is output before the treatment of the specimen is completed.

The temperature adjustor 64 adjusts the temperature of the heat exchange medium in accordance with the order so that the temperature of the specimen table 100 is sufficiently close to the initial temperature T1 thereof at the time t2 where the treatment of the specimen to be treated subsequently is started. The change in temperature of the specimen table 110 during the treatment of the specimen caused by the adjustment in temperature of the heat exchange medium for the specimen to be treated subsequently is made by the time delay negligibly small or substantially zero. Therefore, the treatment of the specimen 101 is restrained from being affected by the adjustment in temperature of the heat exchange medium.

The temperature of the specimen table decreases after the bias is prevented from being generated and the plasma disappears so that the treatment of the specimen is completed, and when a trouble occurs in the operation of the treating unit 23 or vacuum treatment apparatus 10, there is a provability of that an actual time at which the treatment of the specimen to be treated subsequently starts is made different from the calculated time t2. Therefore, the occurrence of the trouble and the variation of the time at which the treatment of the specimen to be treated subsequently starts are monitored (step 611, 614, 615). When the trouble is detected and the newly calculated time t2′ at which the treatment of the specimen to be treated subsequently starts is later than the time t2, the order for the adjustment of the temperature is not output, and the initial reference temperature T1 is used for the desired temperature of the heat exchange medium for the treatment of the specimen 101 to be treated subsequently (step 615). On the other hand, when the time at which the treatment of the specimen to be treated subsequently starts is not changed, the order is output at the time t3 to start the adjustment of temperature of the heat exchange medium for the specimen 101 to be treated subsequently (step 612, 613).

Incidentally, when the occurrence of the trouble of the vacuum treating apparatus 10 is detected after the order is output at the step 613 to cause the change of the time t2 at which the treatment of the specimen 101 to be treated subsequently starts, the order for making the temperature at T1 may be output to the temperature adjustor 64.

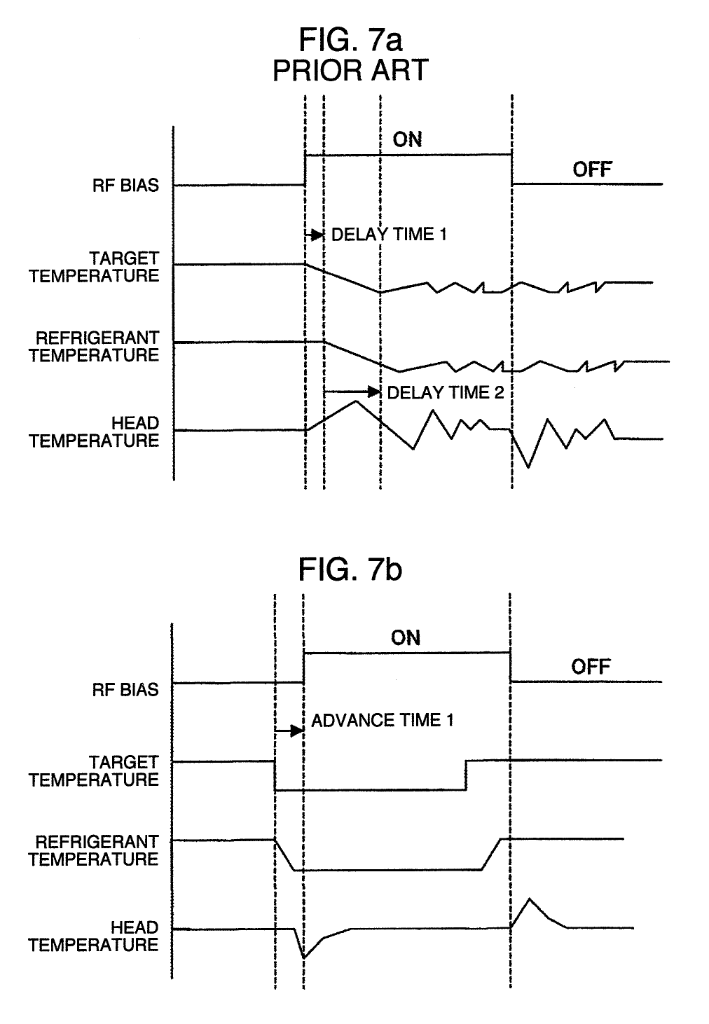

Each of FIGS. 7a and 7b is a time chart showing an operation of the treating unit 13 as shown in FIG. 2 to which the invention is not applied, and the operation of the treating unit 13 as shown in FIG. 2 to which the invention is applied. FIG. 7a shows the operation along a feed-back control of the prior art, and FIG. 7b shows the operation with the temperature adjustment of the invention. In FIG. 7a, since the feed-back control is performed on the basis of the detected temperature of the electrode of the specimen table 100, the ordered temperature is changed after the detection with two time delays.

That is, there is the time delay 1 from the change of the ordered temperature to the start of change in temperature of the heat exchange medium and the time delay 2 as a time period in which the temperature of the head returns to the initial temperature after the temperature of the heat exchange medium is changed. Thereafter, a hunting phenomenon caused by the feed-back control with the time delays occurs.

In FIG. 7b, the order for changing the temperature of the refrigerant is output at a time determined with taking the time delays into consideration on the basis of the forecasted time at which the temperature of the specimen table increases and the forecasted increase of the temperature. Therefore, the temperature at the time where the treatment is started is made closed to the reference temperature although the temperature of the specimen table 100 is increased by the bias. Therefore, an evenness in treating condition such as temperature variation for the plurality of the specimens 101 is improved. Further, in the embodiment, the temperature adjustment on the forecasted temperature is performed without excessive hunting to improve repeatability and process yield of the treatment so that the efficiency of the treatment is increased. In the embodiment, the electrode capable of compensating the time delay to decrease the variation in temperature along the time elapse.

FIG. 1 shows the vacuum treating apparatus 1 for treating simultaneously the plurality of the specimens 101 so that a through-put of the treatment is improved, the parallel treatment for the specimens is performed efficiently, and variation with time elapse is restrained. Capacity coupling type, inductive coupling type, ECR type using microwave or UHF wave, or the like may be used as the plasma source, but the invention is not limited by the type of the plasma source. The plasma etching apparatus is described as the above embodiment, but the invention is applicable to any treating apparatus in which a specimen is heated in a vacuumed condition to be treated. For example, the plasma etching apparatus, plasma CVD apparatus, sputtering apparatus or the like is used as the treating apparatus using the plasma. Alternatively, an treating apparatus for ion implantation, MBE, deposition, low pressure CVD or the like without the plasma may be used.

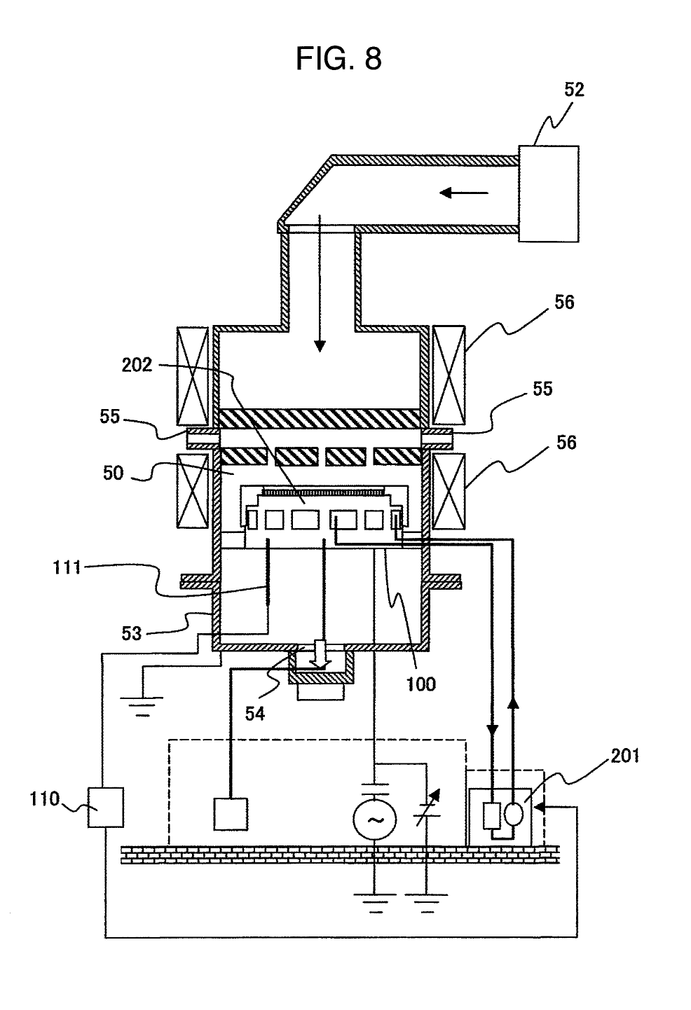

An improvement in responsibility of the temperature control of the specimen table 100 by changing the heat exchange medium is described with making reference to FIG. 8. FIG. 8 is a longitudinal cross sectional view of an example modified from the embodiment shown in FIG. 2. In this drawing, denoting numbers common with those of the above embodiment are not shown.

The modified example is the plasma treating apparatus including a cooler of direct-expansion type in which the heat exchange medium is vaporized in the refrigerant passage in the specimen table 100 to use the specimen table 100 as cooling area for the refrigerating cycle. In the modified example, the cooler of direct-expansion type includes the refrigerating cycle formed by the specimen table 100 and a refrigerant circulating unit 201 contained in the container as the bed 25 and connected to the specimen table 100. The refrigerant circulating unit 201 includes a refrigerant compressor, a condenser, an expansion valve connected in series in order to form the refrigerating cycle to supply a liquid of high-volatile into the refrigerant passage in the electrode. The refrigerating cycle including the specimen table 100 and the refrigerant circulating unit 201 cool the specimen table 100 and the specimen 101 mounted thereon by evaporating the refrigerant in the refrigerant passage in the specimen table with a heat energy received from the specimen table 100 to decrease the temperature of the electrode.

By the cooling device including the refrigerating cycle, a cooling performance is changed by adjusting an opening degree of the expansion valve as pressure control valve in the refrigerant circulating unit 201 to change a temperature at which the refrigerant vaporizes. Since a responsibility of the change of the vaporizing temperature of the refrigerant with respect to the change of the pressure is significantly higher than a responsibility of adjustment with indirect thermal conduction between the heat exchange medium and the refrigerating cycle by the temperature adjustor 64 of the heat exchange medium as shown in FIG. 2, the time delay in the temperature control is significantly improved to increase significantly so-called controllability. The modified example is effective for instantly responding to an abrupt change in temperature of the specimen 101.

It should be further understood by those skilled in the art that although the foregoing description has been made on embodiments of the invention, the invention is not limited thereto and various changes and modifications may be made without departing from the spirit of the invention and the scope of the appended claims.

1. An apparatus for treating with plasma a specimen mounted on a specimen table and a next specimen mounted on the specimen table and treated after the treatment of the specimen is completed, in a vacuumed container, comprising,
a detector for measuring a temperature of the specimen table, and an adjustor for adjusting the temperature of the specimen table obtained when the next specimen is treated to have a value determined on the basis of a predetermined change in temperature of the specimen and one of the temperature of the specimen table measured by the detector and a temperature of returning refrigerant obtained after the treatment of the specimen is started,
wherein the adjustor obtains the predetermined change in temperature of the specimen from the temperatures of the specimen measured in respective conditions in each of which conditions the treatment is continued until a changing rate of the temperature of the specimen becomes not more than a predetermined degree.

2. The apparatus according to claim 1, wherein the adjustor adjusts the temperature of the specimen table obtained when the treatment of the next specimen is started, on the basis of an increase of the temperature of the specimen table measured by the detector after the treatment of the specimen is started.

3. The apparatus according to claim 1, wherein the specimen is transferred out of the vacuumed container after the treatment of the specimen is completed and the plasma disappears in the vacuumed container, and subsequently the next specimen is transferred into the vacuumed container to be mounted onto the specimen table.

4. The apparatus according to claim 1, wherein the adjustor adjusts the temperature of the specimen table obtained when the next specimen is treated, on the basis of an increase of the temperature of the specimen table obtained after the plasma is generated and a decrease of the temperature of the specimen table obtained after the plasma disappears.

5. The apparatus according to claim 1, wherein the adjustor adjusts the temperature of the specimen table obtained when the next specimen is treated, to have a value determined on the basis of the temperature of the specimen table measured by the detector when the specimen is treated before the plasma disappears and a predetermined change in temperature of the specimen obtained when the specimen is treated.
